(19) United States
(12) Patent Application Publication
(10) Pub. No.: US 2016/0150069 A1
(43) Pub. Date: May 26, 2016

(54) WIRELESS INTERACTIVE SYSTEM APPLIED BETWEEN ELECTRONIC DEVICE AND TRIGGER

(71) Applicant: UNITECH ELECTRONICS CO., LTD., HSIN-TIE CITY (TW)

(72) Inventor: SHU-LU CHEN, HSIN-TIE CITY (TW)

(21) Appl. No.: 14/854,977

(22) Filed: Sep. 15, 2015

(30) Foreign Application Priority Data
Nov. 24, 2014 (TW) 103140689

(51) Int. Cl. H04M 1/725; H04W 4/00

(52) U.S. Cl. CPC H04M 1/72533; H04W 4/008

(57) ABSTRACT

A wireless interactive system applied between an electronic device and a trigger is revealed. The wireless interactive system includes an electronic device and a trigger. The electronic device such as a smart phone, a gateway, etc. is connected to the trigger wirelessly by a wireless network such as BLE, WiFi, or Zigbee. Users can define at least one prior event according to their requirements by software program built-in the electronic device. The trigger is a push-button carried by a user. Thus the user can activate the electronic device wirelessly to perform the defined prior event by easy operation of the push-button. Thereby the user can dynamically change interactions between the electronic device and the trigger according to his needs.

### BACKGROUND OF THE INVENTION

The present invention relates to a wireless interactive system applied between an electronic device and a trigger, especially to a wireless interactive system in which an electronic device is connected to a trigger wirelessly by a wireless network. Thus at least one prior event is defined by a software program built-in the electronic device and users can activate the electronic device wirelessly to perform the prior event by easy operation of the trigger.

Along with development of wireless communication/ transmission techniques, a wireless remote control for an electronic device has been studied broadly. Generally, hardware and software functions of a remote controller are set in advance at the manufacturing end. Thus users are unable to be set the remote controller according to their requirements. For example, a television (an electronic device of the present invention) and a remote controller are connected in a one-to-one correspondence. Thus only the corresponding remote controller can turn on the television (electronic device). There are many other electronic devices such as a light, an air conditioner, a stereo set etc used at home. Each of the electronic devices requires a corresponding remote controller set at the manufacturing end. Thus the manufacturing cost of the remote controller is increased. Moreover, the remote controller is unable to be set at the user's end. Thus there is room for improvement and a need to provide a remote controller with simplified design that is easy to be manufactured and used.

Furthermore, the electronic device available now such as a smart phone, a gateway, etc provides more functions day by day. For example, a smart phone provides functions of making or receiving a call, 3G or 4G internet surfing, taking pictures, etc. Each function is defined as an event in the present invention. When a user wants to perform a specific event such as making a specific call, internet surfing or taking a picture instantly etc. by the smart phone, a plurality of procedures is going to be executed. First the user needs to enter a code for unlocking the smart phone. Then the user click or tap an icon on a touch screen of the smart phone. Once the user is doing something else such as walking around or driving on a road, the procedures are unable to be finished quickly and easily. This causes problems in operation. In addition, a gateway arranged within a certain area is used for control of intelligent energy saving devices such as lights, air conditioners, audio devices, etc. within the area. Each time the user enters the area, he needs to operate the gateway for activating these energy saving devices respectively. The operation takes time and causes troubles to users.

The wireless communication/transmission techniques are proven techniques. However, the techniques haven't been applied to an interactive system between an electronic device and a trigger. The present invention combines wireless transmission techniques with remote controller related techniques to form a wireless interactive system between an electronic device and a trigger for convenient operation and lower cost of the trigger.

### SUMMARY OF THE INVENTION

Therefore it is a primary object of the present invention to provide a wireless interactive system applied between an electronic device and a trigger. Wireless connectivity is established between the electronic device and the trigger by a wireless network. Users can use a software program built-in the electronic device to define at least one prior event according to their requirements. The trigger is in a form of a push-button. While in use, the user can turn on the electronic device wirelessly to perform the defined prior event by easy operation of the push-button. Thereby the user can dynamically change interactions between the electronic device and the trigger according to requirements in use. Compared with conventional techniques, the electronic device of the present invention is much more convenient in use and manufacturing cost of the trigger of the present invention is reduced.

The electronic device includes at least one functional device (or module) that provides original functions thereof, at least one software program for users to define at least one prior event, and at least one wireless communication module for signal transmission between the electronic device and the trigger.

The trigger consists of at least one push-button pressed by the user for operation, a wireless communication(transmission) module for signal transmission between the trigger and the electronic device, a functional device such as microcontroller (MCU) for dealing with related information, and a power storage device such as battery for providing the trigger the power required.

The wireless network between the electronic device and the trigger can be bluetooth low energy (BLE), wireless fidelity (WiFi), or Zigbee.

The electronic device can be a smart mobile phone while the trigger can be a bracelet or a hanging ornament with the push-button allowing users to carry. When the user presses the push-button on the bracelet or the hanging ornament, the smart mobile phone is activated wirelessly to perform at least one prior event already defined by the user including, but not limited to, calling a specific friend, surfing the internet, playing music on the user's favorite music list in the smart mobile phone, or taking pictures with the phone camera, etc. Thus the user can use the smart phone more conveniently.

The electronic device can be a gateway arranged at a specific area (such as indoors or outdoors) while a trigger can be a push-button set on a desk top or on a wall for being pressed by users easily and conveniently. The gateway is activated wirelessly to send a signal to a light, an audio equipment, a television or their combinations at the specific area when the user presses the push-button. Thus the light, the audio equipment, the television or their combination is turned on.

The trigger can further be arranged with one of the following devices or their combinations: a light emitting device, a vibration device, an audio signaling device, an identification tag (such as RFID tag or NFC tag), a motion sensing device/mechanism (gyroscope or accelerometer), and a magnet for attachment.

The electronic device further sends signals to the trigger for turning on the devices arranged at the trigger such as the light emitting device, the vibration device, the audio signaling device, etc.

### BRIEF DESCRIPTION OF THE DRAWINGS

FIG. 1 is a schematic drawing showing system structure of an embodiment according to the present invention;

FIG. 2 is a block diagram showing circuit function of an embodiment according to the present invention;

FIG. 3 is a schematic drawing showing another embodiment according to the present invention;

FIG. 4 is a schematic drawing showing a further embodiment according to the present invention;

FIG. 5 is a schematic drawing showing an embodiment of a trigger of a system according to the present invention.

### DETAILED DESCRIPTION OF THE PREFERRED EMBODIMENTS

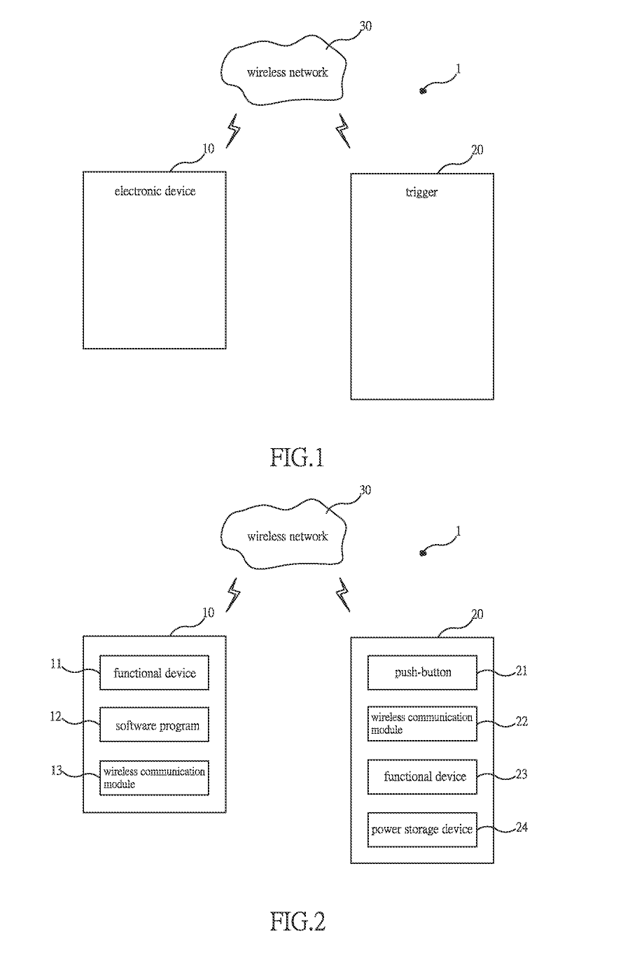

Refer to FIG. 1, a wireless interactive system 1 applied between an electronic device 10 and a trigger 20 is revealed. Wireless connectivity is established between the electronic device 10 and the trigger 20 by means of a wireless network 30. Users can use a software program built-in the electronic device 10 to define at least one prior event according to their requirements. The trigger 20 includes or forms a push-button. While in use, the user can activate the electronic device 10 wirelessly to perform the defined prior event by easy operation of the push-button of the trigger 20. Thereby the user can dynamically change interactions between the electronic device 10 and the trigger 20 according to requirements in use. Compared with conventional techniques, the electronic device 10 of the present invention is much more convenient in use and manufacturing cost of the trigger 20 of the present invention is reduced.

Refer to FIG. 1, the wireless network 30 can be one of the followings-bluetooth low energy (BLE), wireless fidelity (WiFi), and Zigbee.

Besides a functional device (or module) 11 that provides original functions of the electronic device 10, the electronic device 10 further includes a software program 12 for users to define at least one prior event, and a wireless communication module 13 for signal transmission between the electronic device 10 and the trigger 20. The functional device 11 of the electronic device 10 can also includes, but not limited to, the software program 12 and the wireless communication module 13 therein. There is no limit on design of software, hardware and firmware of the electronic device 10.

Refer to FIG. 2, the trigger 20 consists of at least one push-button 21 pressed by the user for activation of the electronic device 10, a wireless communication module 22 for signal transmission between the trigger 20 and the electronic device 10, a functional device 23 such as microcontroller (MCU) for dealing with related information, and a power storage device 24 such as battery for providing the trigger 20 the power required. There is no restriction on design of software, hardware and firmware of the trigger 20.

Moreover, the prior event mentioned above is a function in use defined by the software program 12 built-in the electronic device 10 in advance. The function in use is activated after the push-button 21 of the trigger 20 being pressed by the user. When the electronic device 10 is a smart mobile phone, the prior event can be, but not limited to, calling a specific friend, surfing the internet, playing music on the user's favorite music list in the smart mobile phone, or taking pictures with the phone camera, etc. Furthermore, the prior event can be designed to include at least two prior events. When there are at least two prior events defined, the push-button 21 of the trigger 20 is disposed with a correspondingly circuit design. For example, the first prior event or the second prior event is selected by one click, double-click successively, or press and hold, etc. set in advance.

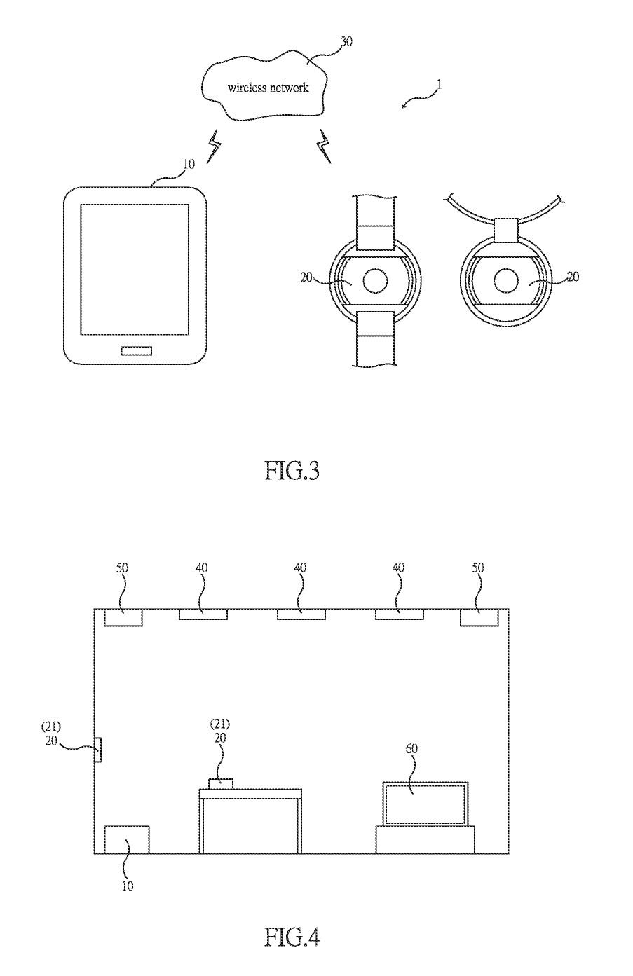

Refer to FIG. 3, in this embodiment, the electronic device 10 is a smart mobile phone while the trigger 20 is a bracelet or a hanging ornament with the push-button 21 carried by the user. When the user presses the push-button 21 on the bracelet or the hanging ornament, the smart mobile phone (10) is activated wirelessly to perform the prior event already defined by the user including, but not limited to, calling a specific friend, surfing the internet, playing music on the user's favorite music list in the smart mobile phone, or taking pictures with the phone camera, etc.

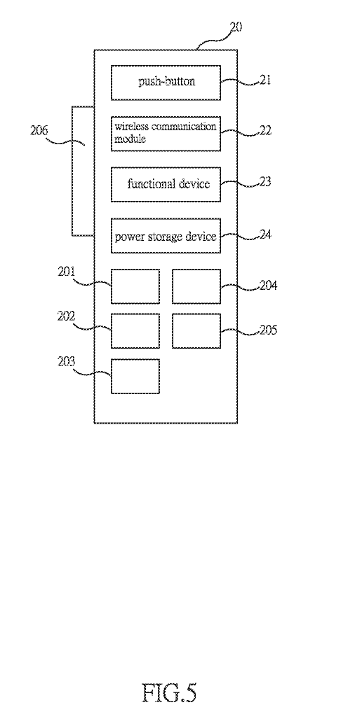

Refer to FIG. 4, a further embodiment according to the present invention is revealed. In this embodiment, an electronic device 10 is a gateway disposed on a specific area (indoors or outdoors) while a trigger 20 is a push-button 21 arranged at a desk top or on a wall for being pressed by users easily and conveniently. The gateway 10 is activated wirelessly to send a signal to a light 40, an audio equipment 50, a television 60 or their combinations arranged at the specific area when a user enters the specific area and presses the push-button 21. Thus the light 40, the audio equipment 50, the television 60 or the combination is turned on.

Refer to FIG. 5, an embodiment of a trigger 20 is revealed. In this embodiment, the trigger 20 is optionally connected to one of the following devices: a light emitting device 201, a vibration device 202, an audio signaling device 203 such as a buzzer, an identification tag 204 such as RFID tag or NFC tag, a motion sensing device/mechanism 205 (gyroscope or accelerometer), and a magnet for attachment 206. Or the trigger 20 can be optionally connected to combinations of the above devices. Thus the trigger 20 has more additional functions and higher efficiency in use. For example, the light emitting device 201, can be used to indicate whether is trigger 20 is in use or in a starting state. The vibration device 202 shows that whether the trigger 20 has received the signal or not. As to the identification tag 204, it is for automatic tracking and used in combination with a door control system. The motion sensing device/mechanism 205, such as gyroscope or accelerometer, is used to recognize a user's gesture and detect whether the user fall down. The magnet for attachment 206 allows the trigger 20 able to be attached to other iron objects so that the trigger 20 is much more convenient in use.

Refer to FIG. 5, the user can send signals to the trigger 20 by the electronic device 10 for turning on the devices arranged at the trigger 20 such as a light emitting diode (LED) light (light emitting device 201), the vibration device 202, or a buzzer (audio signaling device 203) while in use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A wireless interactive system applied between an electronic device and a trigger comprising an electronic device and a trigger;
wherein the electronic device and the trigger wirelessly are connected by a wireless network; a software program is built in the electronic device allowing an user to define at least one prior art according his needs in use;
wherein the trigger includes a push-button;
wherein the trigger sends at least one signal to the electronic device for wirelessly activating the electronic device to perform the prior event when the push-button of the trigger is pressed by the user.

2. The system as claimed in claim 1, wherein the wireless network is selected from the group consisting of bluetooth low energy (BLE), wireless fidelity (WiFi), and Zigbee.

3. The system as claimed in claim 1, wherein the electronic device is a smart phone.

4. The system as claimed in claim 3, wherein the prior event is selected from the group consisting of making a specific phone call, surfing the internet, starting to play music, and taking pictures.

5. The system as claimed in claim 1, wherein the electronic device is a gateway arranged at a specific area.

6. The system as claimed in claim 5, wherein the gateway sends at least one signal for turning on at least one light, at least one audio equipment, at least one television or their combinations at the specific area.

7. The system as claimed in claim 1, wherein the trigger is selected from the group consisting of a bracelet and a hanging ornament, allowing the user to carry.

8. The system as claimed in claim 1, wherein the trigger is disposed with a device selected from the group consisting of a light emitting device, a vibration device, an audio signaling device, an identification tag, a motion sensing device, a magnet for attachment or their combinations.

9. The system as claimed in claim 8, wherein the electronic device sends at least one signal to the trigger for turning on the device disposed on the trigger including the light emitting device, the vibration device, and the audio-signaling device.
